(19) United States
(12) Patent Application Publication
(10) Pub. No.: US 2006/0039274 A1
(43) Pub. Date: Feb. 23, 2006

(54) Method for discretely indicating resource allocation information and a method for reducing load when indicating resource allocation information

(75) Inventors: Won-Hyoung Park, Seoul (KR); Sang-Boh Yun, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/185,042

(22) Filed: Jul. 20, 2005

(30) Foreign Application Priority Data
Aug. 18, 2004 (KR) 65099/2004

(51) Int. Cl. H04J 11/00

(52) U.S. Cl. 370/208

(57) ABSTRACT

A method for discretely indicating resource allocation information regardless of previous resource allocation information in an Orthogonal Frequency Division Multiple Access wireless network system is disclosed. The method includes the steps of defining at least one allocation unit having different sizes and shapes and indexing a total resource region per each allocation unit, and indicating resource information allocated to each terminal of the OFDMA wireless network system based on predetermined allocation unit information and an index value of a predetermined allocation unit.

### PRIORITY

This application claims the benefit under 35 U.S.C. 119(a) of an application entitled “Method For Discretely Indicating Resource Allocation Information And Method For Reducing Load When Indicating Resource Allocation Information” filed with the Korean Intellectual Property Office on Aug. 18, 2004 and assigned Serial No. 2004-65099, the contents of which are incorporated herein by reference.

### BACKGROUND OF THE INVENTION

1. Field of the Invention

The present invention relates to an Orthogonal Frequency Division Multiple Access (OFDMA) wireless communication system. More particularly, the present invention relates to a method for indicating resource allocation information in an OFDMA wireless communication system.

2. Description of the Related Art

Next-generation mobile communication systems will transmit data with superior quality at a high transmission rate to provide subscribers with various improved multimedia services. Recent studies are being conducted on an Orthogonal Frequency Division Multiple Access (OFDMA) scheme to make it possible for the next-generation mobile communication systems to meet the above expectations.

According to the OFDMA scheme, resources are allocated to subscribers through a plurality of sub-carriers (for example, 512 sub-carriers or 1024 sub-carriers) provided in a frequency domain and a plurality of time slots (for example, 20 to 30 time slots) provided in a time domain to transmit upstream and downstream data.

FIG. 1 is a view illustrating a frame structure of a WiBro stands for Wireless Broadband (Wibro) system or an IEEE 802.16 system applied to an OFDMA system.

As shown in FIG. 1, total frequency bands are divided into a plurality of bands 101, 102 and 103, in which each band consists of a plurality of Bins or Tiles (not shown).

A Bin or Tile may include a plurality of sub-carriers. That is, the Bin includes 9 sub-carriers sequentially provided in one OFDMA symbol and has one pilot tone and 8 data tones. In addition, the Tile includes 3 to 6 sub-carriers sequentially provided in one OFDMA symbol and has two pilot tones and 16 data tones.

In addition, the time axis (symbols) is divided into a preamble area 11, a diversity area 12 and an adaptive modulation and coding (AMC) area 13.

The preamble area 11 is used for base station discrimination, channel estimation, synchronization information and system information transmission. The diversity area 12 is used for allocating resources for mobile subscribers, and the AMC area 13 is used for increasing the transmission speed through a frequency-selective adaptive modulation for fixed subscribers.

In addition, a safety channel 14 is provided to prevent overlay.

DL(/UL)-MAP IE (Information Element) used for indicating resource allocation information of the AMC area in such a resource allocation structure is defined in Table 95(/101) of the Institute of Electrical Engineers (IEEE) 802.16-2004 standard.

Table 95(/101) of IEEE 802.16-2004 is shown in Table 1.

TABLE 1
Table 95 - H-ARQ Compact_DL-MAP IE format for band AMC.

| Syntax | Size | Notes |
|---|---|---|
| Compact_{—} DL-MAP_IE | | |
| ( ){ | | |
| DL-MAP Type =1 | 3bits | Shall be set to zero |
| Reserved | 1bit | |
| RCID_IE | Variable | |
| Nep code | 4bits | Code of encoder packet bits (see, |
| | | 8,4,9,2,3,5) |
| Nsch code | 4bits | Code of allocated sub-channels (see, |
| | | 8,4,9,2,3,5) |
| Nband | Nb-Band bits | Number of bands, 0= use BITMAP |
| | | instead |
| If (Nband=0) { | | |
| Band BITMAP | Nb-BITMAP | n-th LSB is 1 if n-th band is selected |
| | bits | |
| } else { | | |
| for (i=0;i<Nband;i++) | | |
| BandIndex | No Index bits | Band selection |
| } | | |
| Allocation Mode | 2bits | Indicates the sub-channel allocation mode |
| | | 00=same number of sub-channels for the |
| | | selected bands |
| | | 01=different number of sub-channels for |
| | | the selected bands |
| | | 10=total number of sub-channels for the |
| | | selected band determined by Nsch code and |
| | | Nep code |
| Reserved | 2bits | Shall be set to zero |
| If (Allocation Mode | | |
| ==00){ | | |
| No. Sub-channels | 8bit | |
| }else if (Allocation Mode | | |
| ==01){ | | |
| For (I=0;I<band | | If Nband is 0, band count is the number of |
| count;I++) | | “1” in BAND BITMAP. Otherwise band |
| | | count is Nband |
| No. Sub-channels | 8bits | |
| } | | |
| H-ARQ_Control_IE | Variable | |
| CQUCH_Control_IE | Variable | |
| } | | |

In Table 1, the “DL-MAP Type” is a value for specifying the type of the DL-MAP IE, and the “RCID_IE” represents an assignment of the IE. In addition, the combination of the “Nep code” and “Nsch code” indicates the number of allocated sub-channels and coding and modulation schemes for the downlink (DL) burst. The “Nband” indicates the number and the position of selected Bands, in which the Bitmap is valid when the Nband is “0”. In addition, the “BandIndex” is a value for indexing the selected Bands.

The Allocation Mode will be described in detail with reference to FIG. 2.

FIG. 2 is a view illustrating sub-channel allocation modes defined in Table 95(/101) of the IEEE 802.16-2004 standard.

According to the sub-channel allocation modes defined in Table 95(/101) of IEEE 802.16-2004, as shown in Table 1, the “Allocation Mode” is assigned after selecting the Bands, thereby indicating resource allocation information.

The Allocation Mode consists of 2 bits and defines three modes.

That is, the “Allocation Mode” is set to binary “00” when the same numbers of sub-channels are allocated in the selected Bands, set to binary “01” when different numbers of sub-channels are allocated in selected Bands, and set to binary “10” when the total number of the sub-channels allocated in the selected Bands is defined by the “Nep code” and “Nsch code”.

Hereinafter, the sub-channel allocation modes will be described with reference to FIG. 2 illustrating Allocation Modes “00”, “01” and “10”.

Referring to FIG. 2A, representing the Allocation Mode “00”, the Bands have sub-channel groups 21, 22, 23 and 24 including regions 201-1, 201-2 and 201-3 occupied by others.

The Allocation Mode “00” represents that the sub-channel groups 21, 22, 23 and 24 have the same-sized allocated regions 202-1, 202-2, 202-3 and 202-4. That is, the same-sized allocated regions 202-1, 202-2, 202-3 and 202-4 are formed in the sub-channel groups 21, 22, 23 and 24 adjacent to the regions 201-1, 201-2 and 201-3.

Referring to FIG. 2B representing the Allocation Mode “01”, the Bands have sub-channel groups 21, 22, 23 and 24 including regions 201-1, 201-2 and 201-3 occupied by others.

The Allocation Mode “01” represents that the sub-channel groups 21, 22, 23 and 24 have the different-sized allocated regions 202-1, 202-2, 202-3 and 202-4. That is, the different-sized allocated regions 202-1, 202-2, 202-3 and 202-4 are formed in the sub-channel groups 21, 22, 23 and 24 adjacent to the regions 201-1, 201-2 and 201-3.

Referring to FIG. 2C representing the Allocation Mode “10”, the Bands have sub-channel groups 21, 22, 23 and 24 including regions 201-1, 201-2 and 201-3 occupied by others.

The Allocation Mode “10” represents that the sub-channel groups 21, 22, 23 and 24 have allocated regions a, b, c and d which are determined by the “Nep code” and “Nsch code”. That is, the allocated regions a, b, c and d are formed while sequentially filling the available regions of the sub-channel groups 21, 22, 23 and 24.

However, according to the above method for indicating resource allocation information, present resource allocation information may indicate a position sequenced to previous resource allocation information, so that it is impossible to ensure an interval when allocating resources to various subscribers, thereby degrading flexibility of resource allocation.

In addition, since the position sequenced to previous resource allocation information is indicated, the present resource allocation information may depend on the previous resource allocation information, so that it is necessary to indicate the resource allocation information after fully recognizing the previous resource allocation information.

### SUMMARY OF THE INVENTION

Accordingly, the present invention has been made to solve the above-mentioned problems occurring in the prior art, and an object of the present invention is to provide a method for discretely indicating resource allocation information regardless of previous resource allocation information in an OFDMA wireless communication system.

Another object of the present invention is to provide a method for indicating resource allocation information, which can discretely indicate the resource allocation information for each subscriber, thereby improving flexibility for resource allocation.

Still another object of the present invention is to provide a method for reducing load when indicating resource allocation information by indicating information of a resource, such as a previously transmitted MAP_IE, if the resource is allocated to a corresponding terminal.

To accomplish these objects, according to one aspect of the present invention, there is provided a method for indicating resource allocation information in an Orthogonal Frequency Division Multiple Access (OFDMA) wireless network system, the method including defining at least one allocation unit having different sizes and shapes and indexing a total resource region per each allocation unit; and indicating resource information allocated to each terminal of the OFDMA wireless network system based on predetermined allocation unit information and an index value of a predetermined allocation unit.

According to another aspect of the present invention, there is provided a method for reducing a load when indicating resource allocation information in an Orthogonal Frequency Division Multiple Access (OFDMA) wireless network system, the method including determining whether a resource allocation region identical to a previous resource allocation region is allocated to predetermined terminals by means of a base station; and transmitting information representing that the resource allocation region allocated to the predetermined terminals is identical to the previous resource allocation region without indicating the resource allocation information for the predetermined terminals if the resource allocation region identical to the previous resource allocation region is allocated to the predetermined terminals.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates a frame structure of a Wibro system or an IEEE 802.16 system applied to an OFDMA system;

FIGS. 2A-2C illustrate sub-channel allocation modes defined in Table 95(/101) of IEEE 802.16-2004;

FIGS. 3A-3D illustrate allocation units having mutually different sizes and shapes, which are allocated to the total resource region and indexed according to an embodiment of the present invention;

FIG. 4 illustrates resource allocation regions for plural subscribers according to an embodiment of the present invention;

FIGS. 5A-5C illustrate allocation modes according to an embodiment of the present invention; and

FIGS. 6A and 6B illustrate resource allocation regions for explaining a method of reducing load generated when indicating resource allocation information according to an embodiment of the present invention, wherein the resource, such as previously transmitted MAP_IE, is allocated to a corresponding terminal.

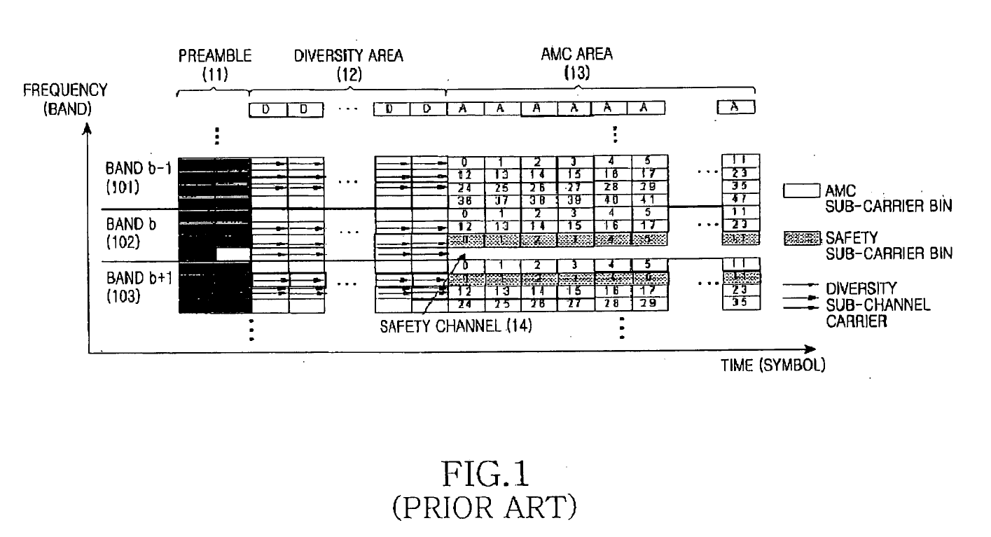

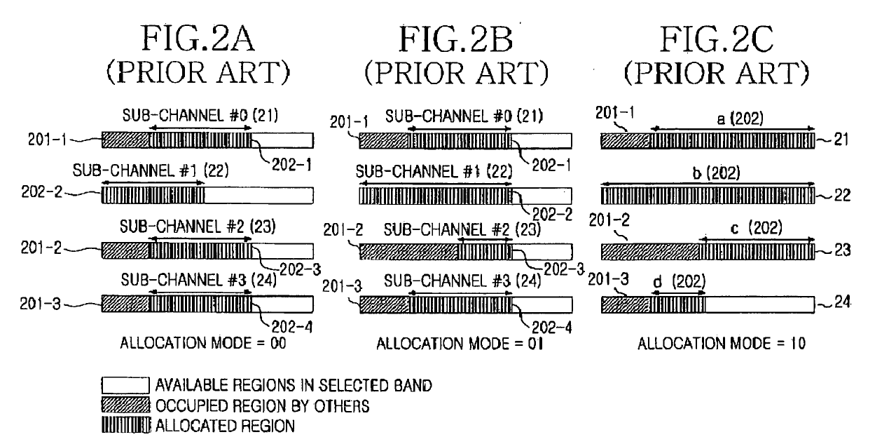

### DETAILED DESCRIPTION OF THE PREFERRED EMBODIMENT

Hereinafter, embodiments of the present invention will be described with reference to the accompanying drawings. In the following detailed description, a detailed description of known functions and configurations incorporated herein will be omitted when it may make the subject matter of the present invention unclear.

According to the present invention, to indicate resource allocation information of an AMC area, allocation units having mutually different sizes and shapes are defined and the total resource region is indexed per each allocation unit, thereby indicating the resource allocation information allocated to each subscriber through a predetermined allocation unit and index information of a corresponding allocation unit.

To this end, allocation units having mutually different sizes and shapes are defined, and then, the total resource region is indexed per each allocation unit.

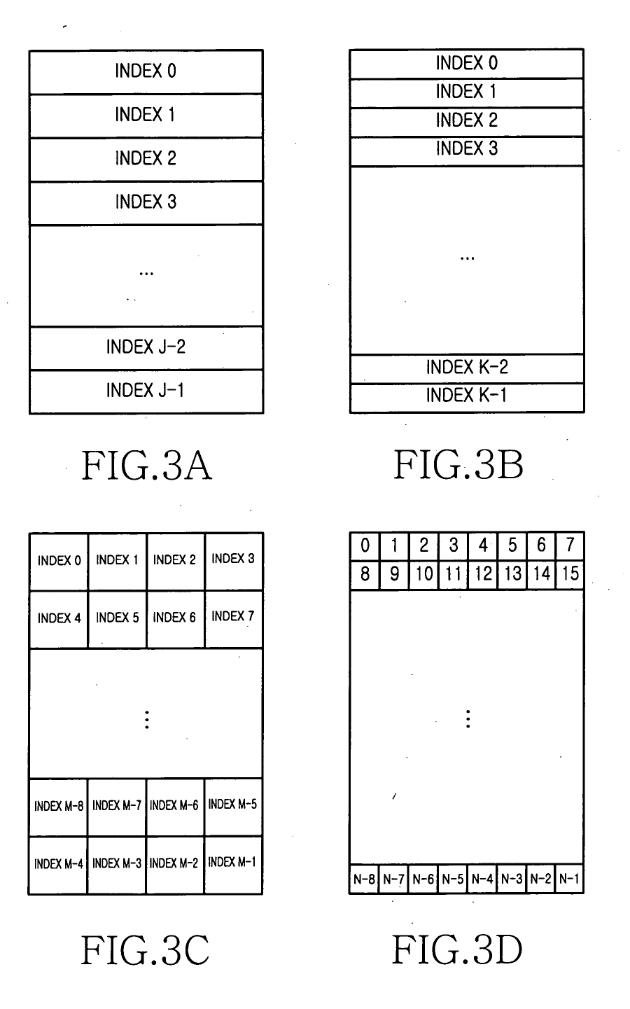

FIG. 3 is a view illustrating allocation units having mutually different sizes and shapes, that are allocated to the total resource region and indexed according to an embodiment of the present invention.

In FIGS. 3A to 3D, the allocation units have mutually different sizes and shapes, that are allocated to the total resource region and indexed according to an embodiment of the present invention. As shown in FIG. 3, the allocation units have various sizes and shapes. The allocation units shown in FIG. 3 are for illustrative purpose only, so the present invention is not limited to the sizes shown. That is, the shape and size of the allocation units can be properly selected according to the type of system.

The allocation unit is a unit for resource allocation and can be variously defined according to time, frequency, code, and direction of indexing.

Time can be represented as a total interval of a corresponding region, 1 slot or 1 symbol, and frequency can be represented as 1 Band or 1 bin. In addition, the direction of indexing includes codes (→ and ↓), in which the code ↓ is shifted into the code → at a boundary area of the Band.

The allocation units shown in FIGS. 3A to 3D have one Band, one sub-carrier, four sub-channels and one sub-channel and are represented as \textcircled{a}, \textcircled{b}, \textcircled{c}, and \textcircled{d}, respectively. In addition, an index value of the allocation unit \textcircled{a} is in a range of \textcircled{a}(0) to \textcircled{a}(J−1), an index value of the allocation unit \textcircled{b} is in a range of \textcircled{b}(0) to \textcircled{b}(K−1), an index value of the allocation unit \textcircled{c} is in a range of \textcircled{c}(0) to \textcircled{c}(M−1), and an index value of the allocation unit \textcircled{d} is in a range of \textcircled{d}(0) to \textcircled{d}(N−1).

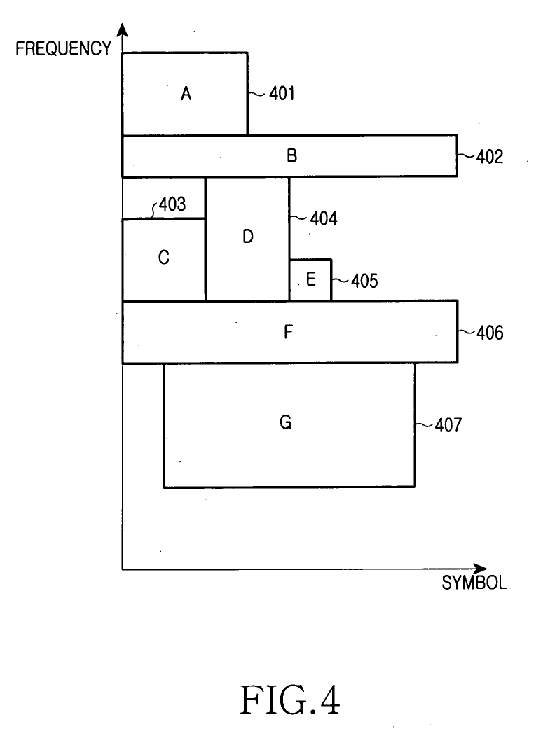

FIG. 4 is a view illustrating resource allocation regions for plural subscribers according to an embodiment of the present invention.

As shown in FIG. 4, resource allocation regions for plural subscribers include A 401, B 402, C 403, D 404, E 405, F 406 and G 407.

The resource allocation regions shown in FIG. 4 can be simply represented by using the allocation unit as shown in FIG. 3. That is, B 402 and C 403 can be represented as \textcircled{b}(0) and \textcircled{c}(8), respectively.

In addition, A 401 can be represented as \textcircled{c}(0) and \textcircled{c}(1). This means continuous resource allocation regions can be simply represented by assigning a start allocation unit index and a total number of the allocation units.

In addition, D 404 can be represented as \textcircled{d}(26), \textcircled{d}(27), \textcircled{d}(34), \textcircled{d}(35), \textcircled{d}(42) and \textcircled{d}(43). This means a rectangular shaped resource allocation region can be simply represented by assigning a start allocation unit index and an end allocation unit index.

Table 2 shows DL(/UL)-MAP IE (Information Element), which indicates resource allocation information of the AMC area according to an embodiment of the present invention.

TABLE 2

| Syntax | Size | Notes |
|---|---|---|
| Compact DL_MAP IE( ){ | | |
| DL_MAP Type | 3bits | Extension type |
| RCID_ID | Variable | |
| Nep code | 4bits | |
| Nsch code | 4bits | |
| Nae | 4bits | |
| Same AUT | 1bit | |
| Same AM | 1bit | |
| Reserved | 2bits | |
| If (Same AUT ==1){ | | |
| AUT | 4bit | |
| } | | |
| If(Same AM==1){ | | |
| AM | 4bits | |
| } | | |
| for(i=0;<Nae;I++){ | | |
| If (Same AUT ==1){ | | |
| AUT | 4bits | |
| } | | |
| If(Same AM==1){ | | |
| AM | 4bits | |
| ) | | |
| If(Same AM==00){ | | |
| Allocation unit index | Laui bits | |
| }else if (AM==01){ | | |
| Start allocation unit index | Laui bits | |
| Number of allocation units | Nau bits | |
| }else if (AM==10){ | | |
| Start allocation unit index | Laui bits | |
| End allocation unit index | Laui bits | |
| } | | |
| } | | |
| H-ARQ Control_IE | variable | |
| CQICH_Control_IE | variable | |
| If!(byte boundary){ | | |
| Padding Nibble | | |
| } | | |
| } | | |

In Table 2, “DL-MAP Type” is a value for specifying the type of the DL-MAP IE.

“RCID_IE” represents an assignment of the IE. In addition, the combination of the “Nep code” and “Nsch code” indicates the number of allocated sub-channels and coding and modulation schemes for the DL burst.

“Nae” (Number of Allocation Elements) indicates the number of allocation elements, in which at least one sub-channel can be allocated to a corresponding burst. In addition, at least one sub-channel can be represented by one allocation element.

When comparing Table 2 with Table 1, it can be seen that there is a difference in relation to AUT (Allocation Unit Type) and AM (Allocation Mode). That is, the present invention relates to AUT and AM.

AUT indicates the types of the allocation units as shown in FIG. 3.

In further detail, “Same AUT” indicates whether all allocation units use the same AUT. Preferably, “0” is set when different AUTs are used and “1” is set when that the same AUT is used.

In addition, “Same AM” indicates whether all allocation units use the same allocation mode. Preferably, “0” is set when the allocation units use different allocation modes and “1” is set when the allocation units use the same allocation mode.

After defining the “Same AUT” and “Same AM”, if the same AUT is used, a predetermined value is used to indicate the AUT.

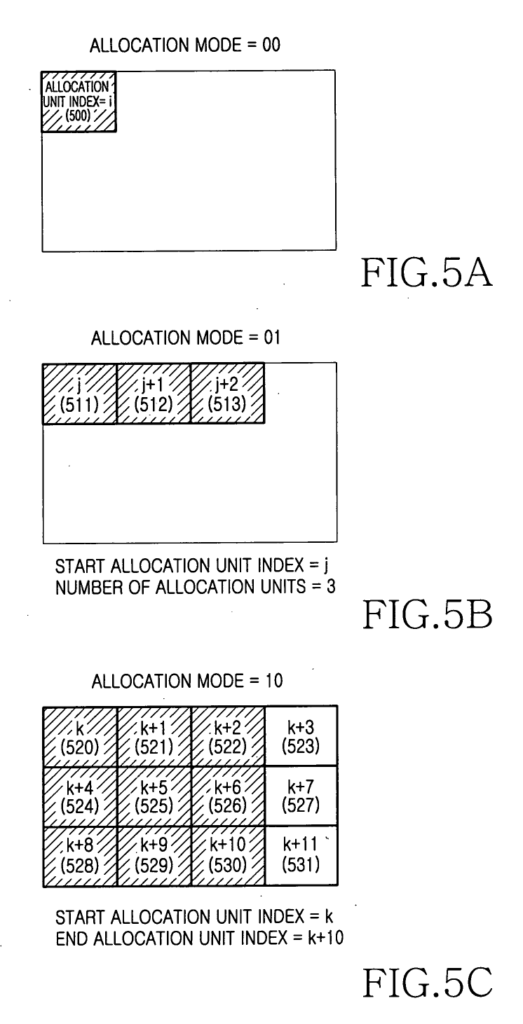

In addition, if the same AM is used, the allocation mode is represented. At this time, allocation mode “00” represents a signal allocation unit is allocated, allocation mode “01” indicates that continuous allocation units are allocated, and allocation mode “10” indicates that allocation units are allocated in a rectangular pattern. This will be described later in detail with reference to FIG. 5.

In the allocation mode “00”, the corresponding allocation region can be indicated by using the index value of the corresponding allocation unit.

In the allocation mode “01”, the corresponding allocation region can be indicated by using the index value of the start allocation unit and the total number of allocation units.

In addition, in the allocation mode “10”, the corresponding allocation region can be indicated by using the index value of the start allocation unit and the index value of the end allocation unit.

FIG. 5 is a view illustrating allocation modes according to an embodiment of the present invention.

FIG. 5A represents the allocation mode “00” indicating that a single allocation unit is allocated in the allocation region. Thus, the allocation region is represented with “i” which is an index value of the corresponding allocation unit 500.

FIG. 5B represents the allocation mode “01” indicating that continuous allocation units 511, 512 and 513 are allocated in the allocation region. To indicate the allocation region, “j” which is an index value of a start allocation unit 511 and “3” which is the total number of the allocation units are used.

FIG. 5C represents the allocation mode “10” indicating that a plurality of allocation units are allocated in the rectangular pattern. To indicate the allocation region, “k” which is an index value of a start allocation unit 520, and “k+10” which is an index value of an end allocation unit, 530 are used.

When the resource allocation information is indicated through the above scheme, overhead can be analyzed as follows.

In the IEEE 802.16 (1024FFT mode) and Wibro standards, if sub-channels “a” and “b” corresponding to symbols (12,6) are allocated to one terminal from non-continuous 2 Bands selected from 24 Bands, the conventional scheme shown in Table 1 requires 4 bits for indicating Nband, 16 bits (8×2 bits) representing the Band index for “a” and “b”, 2 bits for representing the allocation mode, and 16 bits (8×2 bits) for representing the number of sub-channels. Thus, a total of 38 bits are required.

In contrast, according to the present invention, on the assumption that the allocation unit corresponding to 1 Band*6 symbol exists (if total 18 symbols are used for DL_Band AMC, 72 allocation unit indexes (24 Band*3) can be used, so one allocation unit index can be represented with 7 bits), there is required 4 bits for AUT, 4 bits for Nae, 13 bits for the allocation unit corresponding to “a” (2 bits for AM, 7 bits for start allocation unit index, and 4 bits for the number of allocation units) and 9 bits for the allocation unit corresponding to “b” (2 bits for AM, and 7 bits for allocation unit index). Thus, the present invention requires only 30 bits.

The present invention can be applied to the Wibro or IEEE 802.16 standards in various manners.

First, a new type indicating the MAP_IE scheme of the present invention can be added to an extension mode of DL_MAP IE TYPE and UL_MAP IE TYPE fields in Table 87 of the IEEE 802.16 (802.16-2004) standard.

Second, the MAP_IE scheme of the present invention can be represented by using a reserved value of DL_MAP IE TYPE and UL_MAP IE TYPE fields in Table 87 of the IEEE 802.16 (802.16-2004) standard.

Third, the present invention can be represented by using 1 bit of a reserved field in Table 95 H-ARQ Compact_DL_MAP IE of the IEEE 802.16 (802.16-2004) standard.

Fourth, it is also possible to newly define Table 95 of IEEE 802.16 (802.16-2004) such that the Table 95 may indicate the MAP_IE scheme of the present invention as well as the conventional scheme.

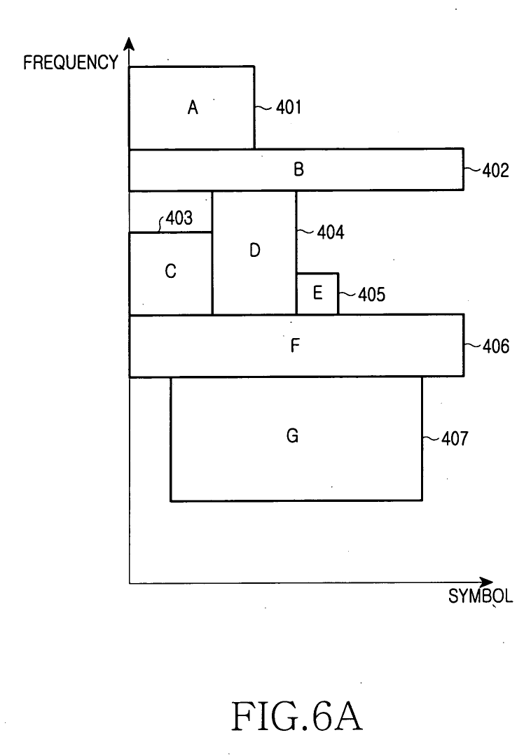

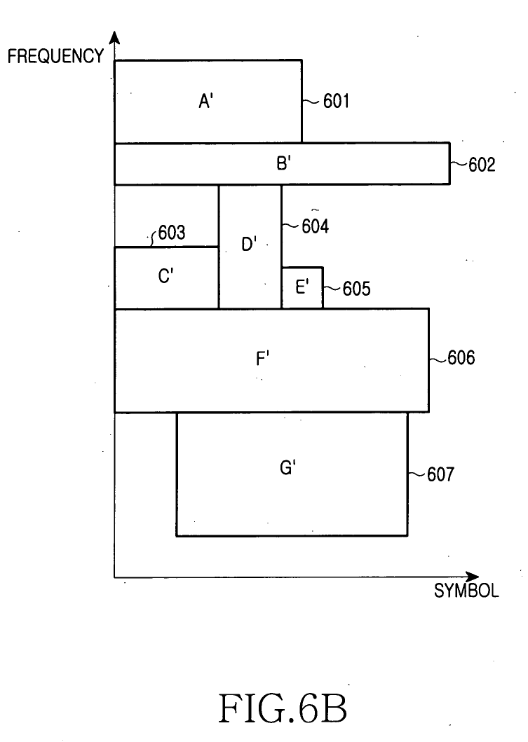

FIGS. 6A and 6B are views illustrating resource allocation regions for explaining a method of reducing load generated when indicating resource allocation information according to an embodiment of the present invention, wherein the resource, such as previously transmitted MAP_IE, is allocated to a corresponding terminal.

Referring to FIG. 6A, the resource allocation regions are variously represented as A 401, B 402, C 403, D 404, E 405, F 406 and G 407 for plural subscribers.

After allocating resources to the above resource allocation regions, the next resource allocation is performed with respect to resource allocation regions A′ 601, B′ 602, C′ 603, D′ 604, E′ 605, F′ 606 and G′ 607 as shown in FIG. 6b. The same character means the same terminal and “′” means the new resource allocation.

As shown in FIGS. 6A and 6B, different resources are allocated to A, C, D, F, and G and the same resource is allocated to B 402 and B′ 602 and E 405 and E′ 605.

In this case, the base station continuously allocates the resources to each terminal through a scheduling operation. If the resource allocation information is transmitted even though the same resource is continuously allocated to the same terminals (for example, B 402 and B′ 602 and E 405 and E′ 605), the MAP indicating the resource allocation information is unnecessarily subject to the overload.

Accordingly, a field indicating that the same resource is allocated to the same terminal is added to the reserved field in Table 95 of the IEEE 802.16 (802.16-2004) standard, thereby reducing the load applied to the MAP.

In addition, binary “11” can be newly set as a value of the AM shown in Table 2 to indicate the same resource allocation.

To detect the same resource allocation for the same terminal in the base station, the base station compares the previously transmitted MAP_IE with a newly allocated MAP_IE when storing and scheduling the previously transmitted MAP_IE.

As described above, according to the present invention, the resource allocation information can be discretely indicated regardless of previous resource allocation information in an OFDMA wireless communication system, thereby ensuring flexibility for resource allocation.

In addition, according to the present invention, the allocation of the resource, such as previously transmitted MAP_IE, can be indicated if the resource is allocated to a corresponding terminal, so the load can be reduced when indicating the resource allocation information.

The method for the present invention can be realized in the form of a program and can be stored in a recoding medium such as a CD ROM, a RAM, a floppy disc, a hard disc or a magneto optical disc to allow a user to utilize the method of the present invention by computer.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for indicating resource allocation information in an Orthogonal Frequency Division Multiple Access (OFDMA) wireless network system, the method comprising the steps of:
i) defining at least one allocation unit having different sizes and shapes and indexing a total resource region per each allocation unit; and
ii) indicating resource information allocated to each terminal of the OFDMA wireless network system based on predetermined allocation unit information and an index value of a predetermined allocation unit.

2. The method as claimed in claim 1, wherein step ii) includes the substeps of:
iii) determining if the resource information allocated to each terminal is indicated by using a same allocation unit type,
iv) determining if the resource information allocated to each terminal is indicated by using a same allocation mode, and
v) indicating the resource information by using an index value of a predetermined allocation unit according to the allocation mode.

3. The method as claimed in claim 2, wherein, in step v), if the allocation mode indicates that a single allocation unit is allocated, a corresponding allocation region is indicated by using an index value of a corresponding allocation unit.

4. The method as claimed in claim 2, wherein, in step v), if the allocation mode indicates that continuous allocation units are allocated, a corresponding allocation region is indicated by using an index value of a start allocation unit and a total number of allocation units.

5. The method as claimed in claim 2, wherein, in step v), if the allocation mode indicates that allocation units are allocated in a rectangular pattern, a corresponding allocation region is indicated by using an index value of a start allocation unit and an index value of an end allocation unit.

6. The method as claimed in claim 2, wherein, in step v), if the allocation mode indicates that a resource allocation region identical to a previous resource allocation region is allocated to a corresponding terminal, the resource allocation information is not indicated.

7. A method for reducing a load when indicating resource allocation information in an Orthogonal Frequency Division Multiple Access (OFDMA) wireless network system, the method comprising the steps of:
i) determining whether a resource allocation region is identical to a previous resource allocation region by means of a base station; and
ii) transmitting information representing that the resource allocation region is identical to the previous resource allocation region without indicating resource allocation information if the resource allocation region is identical to the previous resource allocation region is allocated to the predetermined terminals.
